(19) United States
(12) Patent Application Publication
(10) Pub. No.: US 2008/0134513 A1
(43) Pub. Date: Jun. 12, 2008

(54) Net-Rotating Type Electric Razor

(76) Inventor: Tae-Jun Oh, Gyeonggi-do (KR)

Correspondence Address: CANTOR COLBURN, LLP, 20 Church Street, 22nd Floor, Hartford, CT, 06103, US

(21) Appl. No.: 11/721,727

(22) PCT Filed: Dec. 13, 2005
(86) PCT No.: PCT/KR2005/004259

§ 371 Date: Jun. 14, 2007

(30) Foreign Application Priority Data
Dec. 14, 2004 (KR) 2020040035494

(51) Int. Cl. B26B 19/14

(52) U.S. Cl. 30/43.6

(57) ABSTRACT

Disclosed is a net-rotating type electric razor(10) wherein rotary safety nets(12) are fitted into openings(111) of a cover(11), such that rotary blades(14) are rotated at a high speed by a drive motor(100) while being protected by the rotary safety nets. The electric razor comprises a net rotating vibrator(13) formed with a speed reduction gear(132), a first driving gear(15) and first driven gears(151) engaged with the speed reduction gear of the net rotating vibrator, a second driving gear(16) connected to the first driving gear(15) while being engaged with second driven gears(161), upper-side vibrators(17) mounted to the second driven gears(161), a third driving gear(18) connected to the second driving gear(16) while being engaged with third driven gears(181), and lower-side vibrators(19) mounted to the third driven gears(181).

### TECHNICAL FIELD

The present invention relates to an electric razor wherein one or more rotary blades are rotated at a high speed in accordance with the driving of an interior motor to perform a shaving operation. More particularly, the present invention relates to an electric razor wherein four rotary blades are rotated at a high speed while rotary safety nets for covering the respective blades are rotated at a low speed, such that cut hair can be smoothly sucked into holes of the rotating safety nets during a shaving operation, whereby a more efficient shaving operation can be accomplished with an increased cutting force.

### BACKGROUND ART

Generally, to shave with an electric razor of a type wherein at least one built-in safety net is fixed to a net frame, a user has to repeatedly turn the wrist of a hand gripping the razor this way and that, to cause cut hair to be sucked into holes of the safety net. However, there is a limit to efficiently sucking the cut hair into the holes of the safety net by this repeated wrist movements alone.

Accordingly, in use of this kind of electric razor, the user has to frequently turn his wrist, therefore taking a long time to complete a shaving operation and causing the user to suffer from pain in the wrist and arm of the hand gripping the razor.

To solve the above problems, the applicant of the present invention filed Korean Utility Application No. 20-2000-0035168.

The above Korean Utility Application discloses an electric razor wherein at least one rotary blade, which is protected by use of a safety net, is rotated at a high speed in accordance with the driving of a motor to perform a shaving operation. The disclosed electric razor comprises: at least one rotary safety net provided with a ring gear, a shaft hole being perforated through a rotation center of the safety net; a net frame having at least one safety net opening, through which the safety net is rotatably fitted; and a second driving gear mounted to the front end of a forwardly extending rotating shaft of a motor for the driving of the safety net.

Although the disclosed prior art solves problems of conventional electric razors, there still exists a need that the safety net is rotated in a direction opposite to the blade at a more reduced speed when the blade is rotated to perform a shaving operation, in order to ensure cut hair can be more smoothly sucked into holes of the safety net while achieving a more efficient shaving operation.

### DISCLOSURE OF INVENTION

### Technical Problem

Therefore, the present invention has been made in view of the above problems, and it is an object of the present invention to provide an electric razor wherein the rotating speed of a rotary safety net can be appropriately reduced, whereby cut hair can be smoothly sucked into holes of the safety net during a shaving operation, and the cutting force of the electric razor can be increased.

### Technical Solution

In accordance with the present invention, the above and other objects can be accomplished by the provision of a net-rotating type electric razor in which one or more rotary safety nets are fitted into safety net openings of an outer cover, respectively, such that one or more rotary blades are rotated at a high speed to perform a shaving operation in accordance with the operation of a drive motor while being protected by the rotary safety nets, respectively, the net-rotating type electric razor comprising: a net rotating vibrator engaged with a lower end of a net rotating gear that is used to rotate the safety nets, the net rotating vibrator being formed throughout a lower end of an inner circumference thereof with a speed reduction gear; a first driving gear engaged at opposite circumferential locations thereof with a pair of first driven gears, which are engaged with the speed reduction gear of the net rotating vibrator; a second driving gear connected to the lower side of the first driving gear by use of a motor shaft while being engaged at opposite circumferential locations thereof with a pair of second driven gears; a pair of upper-side vibrators mounted to the top of the second driven gears, respectively; a third driving gear connected to the lower side of the second driving gear by use of the motor shaft while being engaged at opposite circumferential locations thereof with a pair of third driven gears; and a pair of lower-side vibrators mounted to the top of the third driven gears, respectively.

### ADVANTAGEOUS EFFECTS

With the above-described configuration, when the rotary blades are rotated in accordance with the driving of the motor, the safety nets are rotated at a lower speed than that of the blades, whereby cut hair can be smoothly sucked into holes of the safety nets, and the cutting efficiency of the electric razor can be improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the external appearance of a net-rotating type electric razor according to a preferred embodiment of the present invention;

FIG. 2 is an exploded perspective view of the net-rotating type electric razor of FIG. 1;

FIG. 3 is a side view, partially in section, of the net-rotating type electric razor of FIG. 1;

FIGS. 4 to 6 are perspective views illustrating the configuration of a net rotating vibrator provided in the net-rotating type electric razor according to the present invention;

FIG. 7 is a side view, partially in section, illustrating a net-rotating type electric razor according to another preferred embodiment of the present invention;

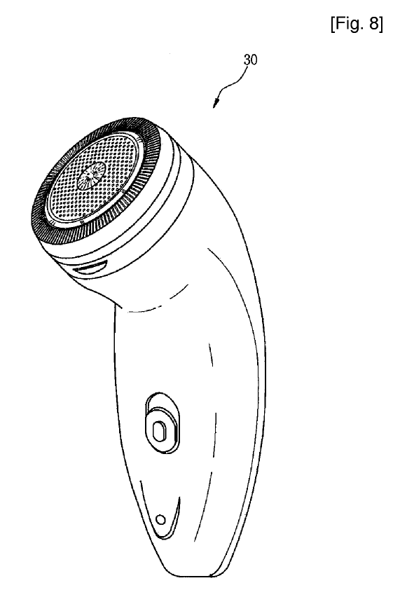

FIG. 6 is a perspective view illustrating the external appearance of a net-rotating type electric razor according to yet another preferred embodiment of the present invention; and

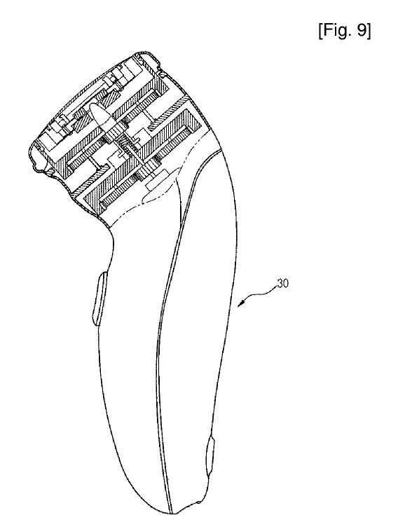

FIG. 7 is a side view, partially in section, of the net-rotating type electric razor of FIG. 6.

### MODE FOR THE INVENTION

Now, preferred embodiments of the present invention will be described in detail with reference to the accompanying drawings.

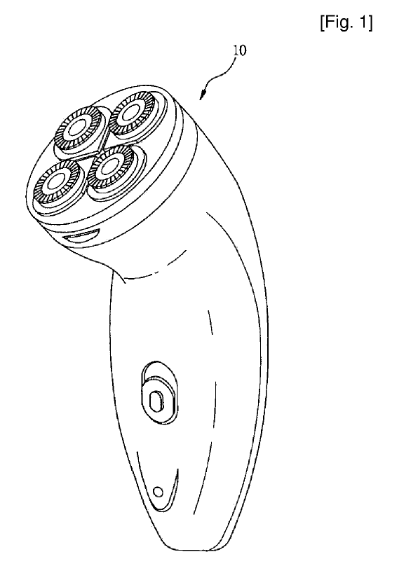

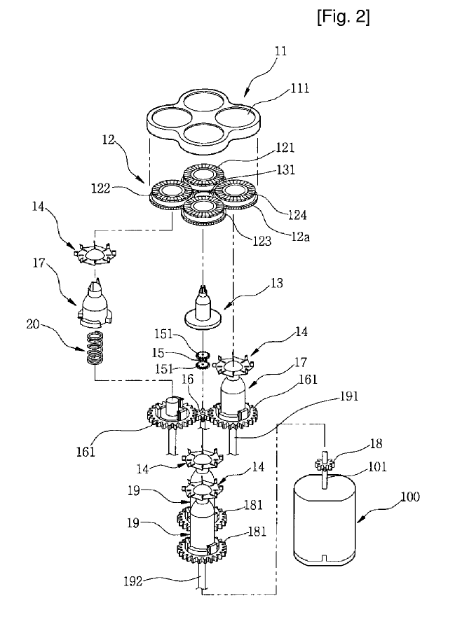

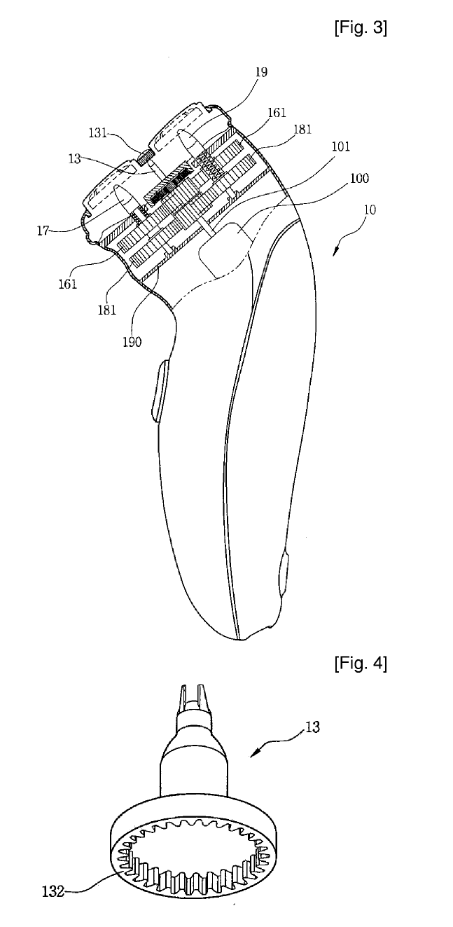

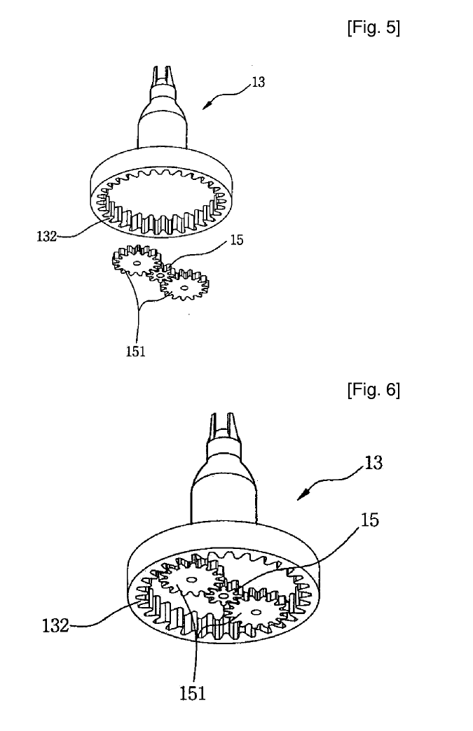

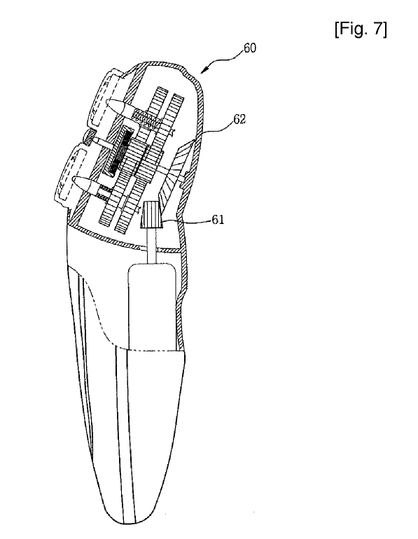

FIG. 1 is a perspective view illustrating the external appearance of a net-rotating type electric razor according to a preferred embodiment of the present invention. FIG. 2 is an exploded perspective view of the net-rotating type electric razor of FIG. 1. FIG. 3 is a side view, partially in section, of the net-rotating type electric razor of FIG. 1. FIGS. 4 to 6 are perspective views illustrating the configuration of a net rotating vibrator provided in the net-rotating type electric razor according to the present invention. FIG. 7 is a side view, partially in section, illustrating a net-rotating type electric razor according to another preferred embodiment of the present invention. FIG. 8 is a perspective view illustrating the external appearance of a net-rotating type electric razor according to yet another preferred embodiment of the present invention. FIG. 9 is a side view, partially in section, of the net-rotating type electric razor of FIG. 8.

Referring to FIGS. 1 to 3, the net-rotating type electric razor according to the preferred embodiment of the present invention, which is designated as reference numeral 10, has a configuration wherein a rotary safety net assembly 12 is fitted into safety net openings 111 of an outer cover 11, such that one or more rotary blades 14 are rotated at a high speed in accordance with the operation of a drive motor 100 while being protected by the rotary safety net assembly 12, whereby an efficient shaving operation can be accomplished.

As shown in FIGS. 4 to 6, the net-rotating type electric razor of the present invention is characterized in that a net rotating vibrator 13 is engaged with the lower end of a net rotating gear 131 that is used to rotate the rotary safety net assembly 12, and a speed reduction gear 132 is formed throughout the lower end of an inner circumference of the net rotating vibrator 13.

Specifically, if the net rotating gear 131 is rotated upon receiving the rotating force of the net rotating vibrator 13, the net rotating gear 131 operates to rotate the rotary safety net assembly 12, i.e. four rotary safety nets 121, 122, 123, and 124. Here, a net gear 12a is formed at the lower end of an outer circumference of each of the rotary safety nets 121, 122, 123, and 124.

In the embodiment of the present invention, four rotary blades 14 are mounted inside the first to fourth rotary safety nets 121 to 124, respectively. Among the four rotary blades 14, two blades 14, mounted inside the first and third safety nets 121 and 123, are coupled with lower-side vibrators 19, respectively. The remaining blades 14, mounted inside the second and fourth safety nets 122 and 124, are coupled with upper-side vibrators 17, respectively.

Specifically, the net-rotating type electric razor of the present invention is characterized in that: a pair of first driven gears 151 are engaged with the speed reduction gear 132 of the net rotating vibrator 13, and in turn, a first driving gear 15 is engaged between the first driven gears 151; the first driving gear 15 is connected to the upper side of a second driving gear 16 by use of a motor shaft 101, and in turn, the second driving gear 16 is engaged at opposite circumferential locations thereof with a pair of second driven gears 161; the upper-side vibrators 17 are mounted to the top of the second driven gears 161, respectively; a third driving gear 18 is connected to the lower side of the second driving gear 16 by use of the motor shaft 101 and the third driving gear 18 is engaged at opposite circumferential locations thereof with a pair of third driven gears 181; and the lower-side vibrators 19 are mounted to the top of the third driven gears 181, respectively.

In addition, a stationary bracket 190 is mounted in the electric razor such that a pair of first driven gear shafts 191 for supporting the pair of second driven gears 161 and a pair of second driven gear shafts 192 for supporting the pair of third driven gears 181 are inserted into and fixed to the stationary bracket 190.

In another preferred embodiment of the present invention, as shown in FIG. 7, the net-rotating type electric razor, which is designated as reference numeral 60, may comprise an upper bevel gear 62, and a lower bevel gear 61.

In yet another preferred embodiment of the present invention, as shown in FIGS. 8 and 9, the net-rotating type electric razor, which is designated as reference numeral 30, may comprise a single rotary safety net.

### INDUSTRIAL APPLICABILITY

As apparent from the above description, with the combination of the plurality of driving and driven gears and vibrators, one or more rotary safety nets are able to rotate at an appropriately reduced speed in the same direction as the rotary blades when the rotary blades are rotated to perform a shaving operation, whereby cut hair can be smoothly sucked into holes of the rotating safety nets in a hair cutting direction. Consequently, the present invention has the effect of achieving a rapid and efficient shaving operation while allowing a user to conveniently perform a shaving operation with fewer wrist movements.

Although the preferred embodiments of the net-rotating type electric razor according to the present invention have been disclosed for illustrative purposes, those skilled in the art will appreciate that various modifications, additions and substitutions are possible, without departing from the scope and spirit of the invention as disclosed in the accompanying claims.

1. A net-rotating type electric razor in which one or more rotary safety nets are fitted into safety net openings of an outer cover, respectively, such that one or more rotary blades are rotated at a high speed to perform a shaving operation in accordance with the operation of a drive motor while being protected by the rotary safety nets, respectively, the net-rotating type electric razor comprising:
a net rotating vibrator engaged with a lower end of a net rotating gear that is used to rotate the safety nets, the net rotating vibrator being formed throughout a lower end of an inner circumference thereof with a speed reduction gear;
a first driving gear engaged at opposite circumferential locations thereof with a pair of first driven gears, which are engaged with the speed reduction gear of the net rotating vibrator;
a second driving gear connected to the lower side of the first driving gear by use of a motor shaft while being engaged at opposite circumferential locations thereof with a pair of second driven gears;
a pair of upper-side vibrators mounted to the top of the second driven gears, respectively;
a third driving gear connected to the lower side of the second driving gear by use of the motor shaft while being engaged at opposite circumferential locations thereof with a pair of third driven gears; and
a pair of lower-side vibrators mounted to the top of the third driven gears, respectively.
